(19) United States
(12) Patent Application Publication
(10) Pub. No.: US 2026/0300891 A1
(43) Pub. Date: Oct. 1, 2026

(54) SYSTEM AND METHOD FOR PLAN GENERATION

(71) Applicant: Runway Financial, Inc., Walnut, CA (US)

(72) Inventors: Siqi Chen, Walnut, CA (US); Arya Asemanfar, Walnut, CA (US); Adam Georgiou, Walnut, CA (US)

(73) Assignee: Runway Financial, Inc., Walnut, CA (US)

(21) Appl. No.: 19/477,254

(22) PCT Filed: Jun. 17, 2024
(86) PCT No.: PCT/US2024/034345

§ 371 Date: Oct. 21, 2025

Related U.S. Application Data
(60) Provisional application No. 63/508,848, filed on Jun. 16, 2023.

(51) Int. Cl. G06Q 10/067

(52) U.S. Cl. CPC G06Q 10/067

(57) ABSTRACT

In variants, a method for plan generation can include: determining a set of plans, selecting a plan, optionally determining a set of tasks for the selected plan, optionally performing the set of tasks, and optionally determining a set of explanations for a primary model. However, the method can additionally and/or alternatively include any other suitable elements.

### CROSS-REFERENCE TO RELATED APPLICATIONS

This application claims the benefit of U.S. Provisional Application No. 63/508,848 filed 16 Jun. 2023, which is incorporated herein in its entirety by this reference.

### TECHNICAL FIELD

This invention relates generally to the financial analysis field, and more specifically to a new and useful method and system for plan generation in the financial analysis field.

### BRIEF DESCRIPTION OF THE FIGURES

FIG. 1 is a flowchart representation of a variant of the method.

FIGS. 2A-2C are illustrative examples of determining a set of plans.

FIG. 3 is a first illustrative example of a financial model (e.g., a financial summary).

FIG. 4 is a second illustrative example of a financial model (e.g., sale & marketing).

FIG. 5 is a third illustrative example of a financial model (e.g., revenue).

FIG. 6 is an illustrative example of key operating metrics and plans.

FIG. 7 is an illustrative example of plans (e.g., marketing plan, engineering roadmap, and series B fundraising).

FIG. 8 is an illustrative example of semi-automatically determining a function for a financial model.

FIG. 9 is a schematic representation of a variant of generating a set of tasks to execute a plan created by the model.

FIG. 10 is an illustrative example of the determined set of plans given a prompt.

FIG. 11 is an illustrative example of a prompt template.

FIGS. 12A-12B are illustrative examples of a prompt template populated with context.

FIG. 13 is an illustrative example of determining a set of explanations.

FIG. 14 is an illustrative example of receiving a goal and generating a plan based on the goal.

FIG. 15 is an illustrative example of providing an explanation.

FIG. 16 is a schematic representation of a variant of the system.

### DETAILED DESCRIPTION

The following description of the embodiments of the invention is not intended to limit the invention to these embodiments, but rather to enable any person skilled in the art to make and use this invention.

### 1. Overview

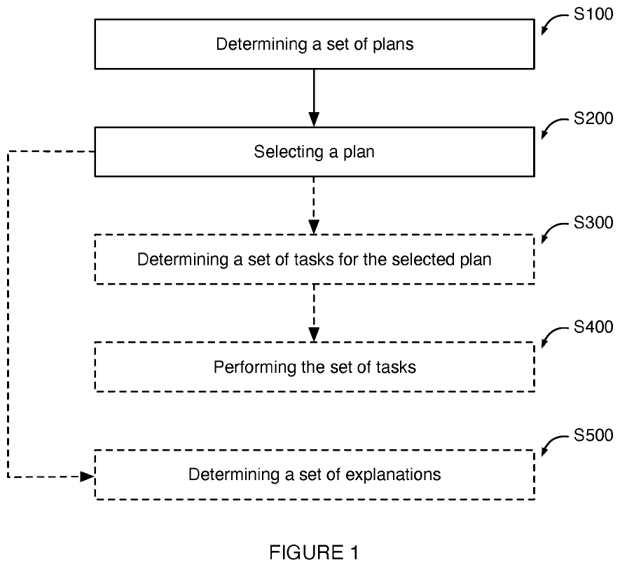

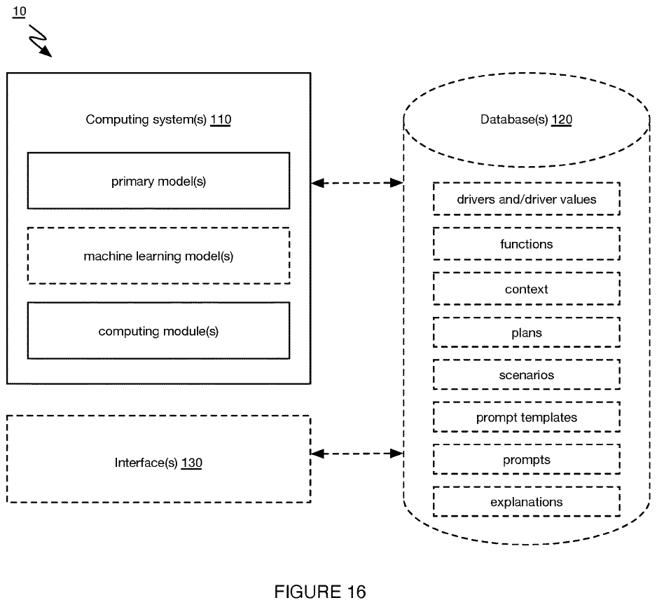

As shown in FIG. 1, variants of the method for plan generation can include: determining a set of plans S100, selecting a plan S200, optionally determining a set of tasks for the selected plan S300, optionally performing the set of tasks S400, and optionally determining a set of explanations S500. However, the method can additionally and/or alternatively include any other suitable elements. As shown in FIG. 16, variants of the system 10 can include: one or more computing systems 110, optionally one or more databases 120, and optionally one or more interfaces 130. However, the system 10 can additionally and/or alternatively include any other suitable components.

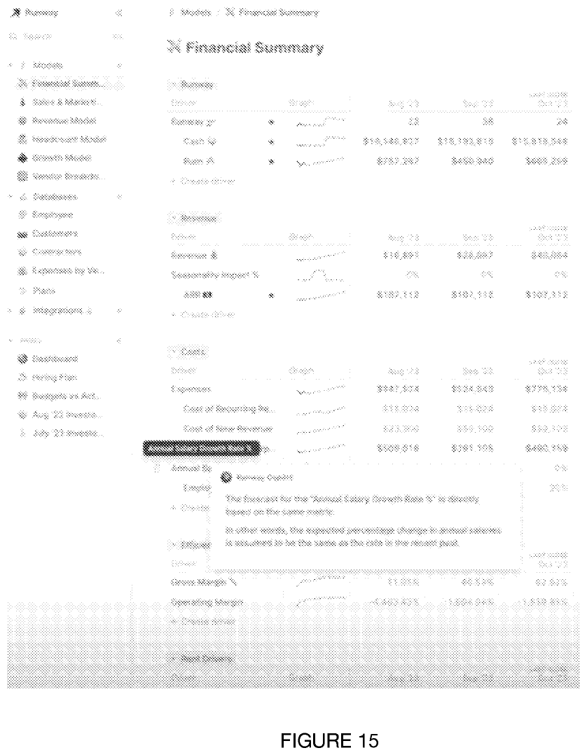

The system and/or method can function to automatically provide insight into and/or modify a complex multivariate model. In examples, the system can: provide human-readable descriptions of a model variable and optionally its relationships or impact on higher-level metrics; generate candidate plans (e.g., model variable value sets) to achieve a goal expressed in abstract natural-language (e.g., example shown in FIG. 15); and/or provide other model insights. In a specific example, the technology can generate one or more plans (e.g., variable value sets) for an entity (e.g., company, individual, etc.) that achieves a set of goals, given a set of constraints, based on a set of controllable variables (e.g., drivers) of a primary model (e.g., a financial model).

One or more variations of the system 10 and/or method can omit one or more of the above elements and/or include a plurality of one or more of the above elements in any suitable order and/or arrangement.

### 2. Examples

In an example, the method for plan generation can include: determining a prompt or other input for a machine learning model that includes a set of goals, a set of constraints, and/or context (e.g., existing plan context, business related context, etc.); providing the prompt, a set of controllable variables (e.g., drivers) of a primary model to the machine learning model, wherein the machine learning model generates a set of candidate plans (e.g., a set of target variable values, a set of target variable value adjustment schedules, etc.) based on the prompt; running each candidate plan through the primary model to simulate outcomes (e.g., model outputs) for each candidate plan; optionally evaluating the outcomes (e.g., to determine whether the outcome satisfies the goal or prompt); optionally feeding the outcomes back into the machine learning model (e.g., when the set of goals are not satisfied), wherein the machine learning model can be adjusted (e.g., finetuned, trained, primed, using reinforcement learning, etc.) based on the candidate plan outcomes; optionally generating updated candidate plans using the updated machine learning model; and selecting a plan from the set of candidate plans for implementation. In variants, the machine learning model can also receive a representation of the model structure alongside the controllable variables, such as: a description of the model structure (e.g., generated using a secondary ML model), a description of each controllable variable (e.g., generated using a secondary ML model), a graph representation (e.g., wherein each node represents a variable and the edges represent inter-variable relationships), a tokenized representation (e.g., of the graph or the descriptions), and/or other model structure representation.

In variants, a machine learning model (e.g., the same or different model from the model that generated the plans or a second model) can also generate a set of tasks given the plan (e.g., given the target variable values), wherein the tasks can be sent to a set of entities (e.g., users, systems, vendors, etc.) that implement the tasks to implement the plan. In variants, a machine learning model (e.g., the same model that generated the plans, the same model that generated the tasks, a different model, etc.) can generate a set of explanations (e.g., description of a plan, description of a driver, explanation of a driver value, etc.) for the primary model and/or plan, given the set of drivers of the primary and a set of prompts, wherein each prompt is determined by populating a prompt template with context.

In an illustrative example, the method can include: determining a natural language description of a primary model, descriptions for a set of drivers (independent variables) and the associated relationships (e.g., equations); prompting a foundation model with the primary model's natural language description and a goal; receiving one or more candidate plans (e.g., each including a timeseries of independent variable values) from the foundation model; simulating each plan using the primary model; and selecting the candidate plan that best satisfies the goal (e.g., generates an output closest to the goal) for execution.

However, the method can be otherwise performed.

### 3. Technical Advantages

Variants of the technology for plan generation can confer one or more advantages over conventional technologies.

First, variants of the technology can enable automatic generation of plans to achieve goals, given constraints, based on a primary model, which enables new plans to be determined for different models at scale. This can enable users to identify favorable plans in an objective way without toggling the drivers of the financial model in a tedious trial-and-error process, by using enumeration, by using an exhaustive search, and/or by using brute force approaches, which, in turn, can save computational resources (e.g., computing power and memory) by reducing the number of candidate plans that need to be stored and simulated. In such variants, drivers of the financial model and a prompt are provided to a foundation model (e.g., a transformer model, such as a GPT (generative pre-trained) model, etc.) that generates candidate plans, wherein the candidate plans are simulated on the financial model to determine simulated driver outputs. The simulated driver outputs are optionally fed back into the GPT model to generate updated plans. In variants, variants of the technology can be more facile for the user. For example, the foundation model can be a natural-language model configured to ingest and/or output data in natural language instead of tensors or other mathematical representations.

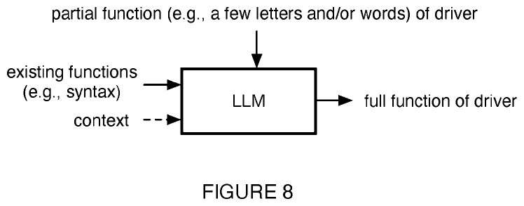

Second, variants of the technology can provide autocompletion of functions (e.g., formulas) for drivers; example shown in FIG. 8 (e.g., wherein the foundation model, primed on other functions, can automatically generate a driver function given a partial function). This can enable users with non-extensive financial background to set up financial models in a facile manner. In variants, when determining a function for a driver, a large language model is primed using existing functions (e.g., based on syntax) for other drivers, ingests context (e.g., business related context) and a few letters and/or words for the target driver (e.g., user input), and outputs the function for the driver.

Third, variants of the technology can enable complex, detailed plans (e.g., variable value adjustments) to be automatically determined, based on an abstract, qualitative, and/or subjective goal. This can be accomplished by leveraging foundation models (e.g., transformer models) trained on a large corpus of data from a plurality of domains, and by leveraging a primary model that models the effects of the variable value adjustments on one or more outcomes (e.g., metrics).

Fourth, variants of the technology can enable automatic generation of human readable explanations (e.g., description of a driver, description of a plan, etc.) for a financial model. In such variants, drivers of the financial model and prompts are provided to a foundation model (e.g., a transformer model, such as a GPT (generative pre-trained) model, etc.) that generates explanations, where the prompts are determined by populating prompt templates (e.g., a generic prompt) with context specifics. Alternatively, a description of the model architecture (e.g., context) can also be provided as an input to the foundation model. In examples, due to inference latency, the explanations can be pre-generated without user request, such that a user can immediately consume the explanations of drivers, driver values, and/or plans, on a graphical user interface when a cursor is hovering over them using a pregenerated explanation.

Fifth, variants of the technology can enable foundation models to increase performance when generating plans and/or explanations by providing well-formed context (e.g., existing plan context, business related context, drivers and/or driver values, functions, plans, etc.) to the foundation model. Currently, the lack of structure in spreadsheets make it challenging to provide context to a foundation model. All elements in a spreadsheet are understood by the person who built it, but the elements themselves lack labels that can be consumed by a model since each cell includes a different set of variables and relationships. In contrast, since variants of the technology rely on variable-based models that are programmatically represented (e.g., instead of spreadsheet models or cell-based models), the data is inherently labeled, and the relationships between data objects (variables, “drivers”) are inherently defined. This structure can be used to determine the context (e.g., deterministic context) (e.g., current variable values, history of variable values, variable relationships, etc.) for the model, which, in turn, can enable more accurate model descriptions to be generated, more optimized plans to be generated, and/or otherwise improve technology performance by accounting for model context.

Sixth, the primary models are multivariate models with multiple independent variables (drives), each with multiple potential variable values. This results in a search space that is incredibly large (e.g., all permutations of all variables' values), which is computationally impossible to comprehensively explore in a reasonable manner. In variants, the technology can streamline the search through the enormous search space by leveraging the semantic connections (e.g., reasoning) embedded in trained foundation models between drivers (independent variables) and goals. In variants, the technology can also generate qualitative plans for subjective or qualitative goals by leveraging the semantic connections embedded in trained foundation models.

Seventh, variants of the technology can enable faster and/or more efficient processing. For example, the primary model can be represented as a graph of interrelated variables (e.g., wherein the relationships can optionally be time-dependent) and/or as an embedding (e.g., embedded representation of the variables and relationships, generated by an encoder or other model). This can reduce the amount of memory needed to store the primary model (e.g., in contrast with a spreadsheet or model with variables, relationships, and values), and can reduce the number of tokens required to represent the primary model for the foundation model input. In the latter variant, this can improve the speed of foundation model inference, since less information needs to be interpreted.

However, further advantages can be provided by the system and method disclosed herein.

### 4. System

The method can be performed using a system 10 (example shown in FIG. 16), including: one or more computing systems 110, optionally one or more databases 120, optionally one or more interfaces 130, and/or any other suitable components. However, the method can additionally and/or alternatively be performed using any other suitable system. The system 10 can function to facilitate execution of the method. However, the system 10 can provide any other suitable functionality.

### 4.1. Primary Models

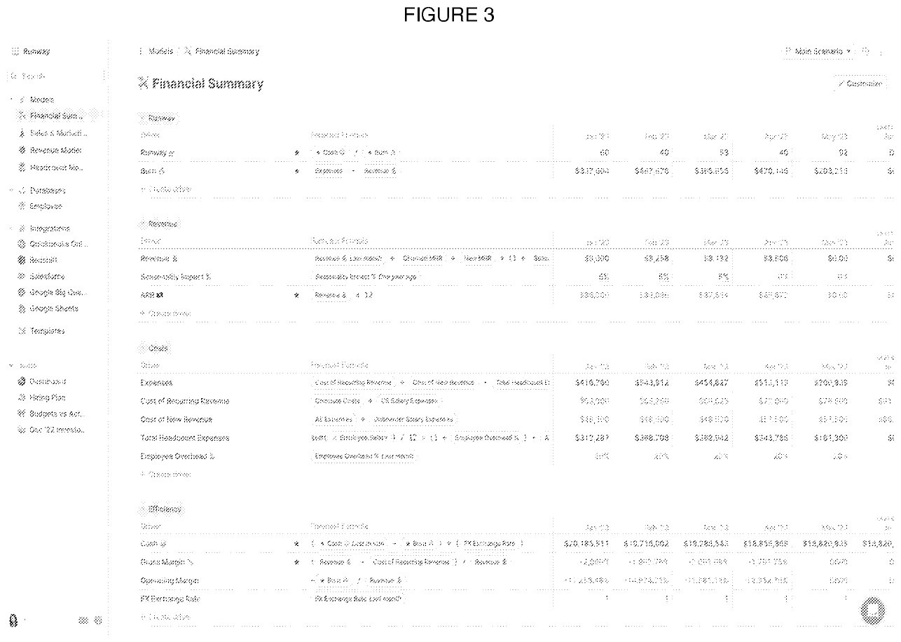

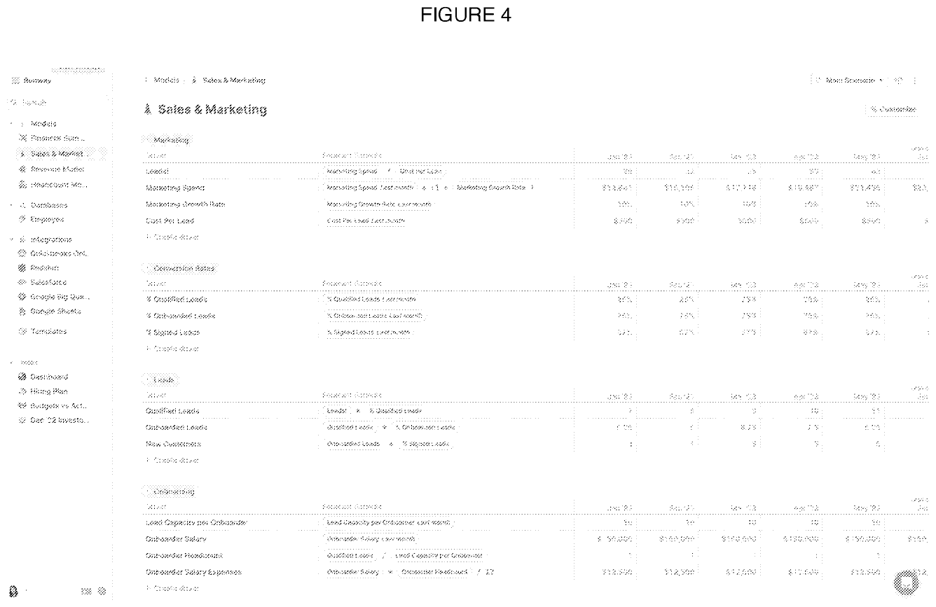

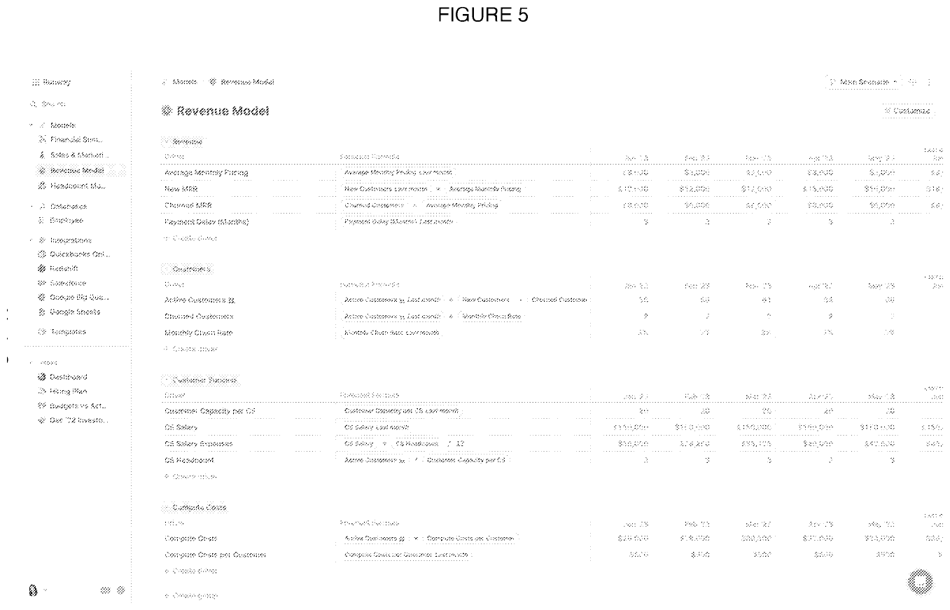

The system 10 and/or method can include and/or be used with one or more primary models (e.g., financial models); examples shown in FIG. 3, FIG. 4, and FIG. 5. The one or more primary models can function to model the business and/or financials of one or more entities. However, the one or more primary models can have any other suitable functionality. The system 10 can include one or more primary models for: one or more entities, one or more users, one or more time intervals, combinations thereof, and/or any other suitable parameters. Each primary model is preferably associated with a single entity, but can additionally and/or alternatively be associated with multiple entities, and/or any other suitable number of entities. The primary model is preferably a deterministic model, but can additionally or alternatively be a non-probabilistic model, a probabilistic model, a stochastic model, and/or be any other suitable model. The primary models are preferably variable-based models (e.g., include a set of variables and associated relationships with other variables within the set), but can alternatively be a cell-based model (e.g., spreadsheet) or other model. The primary models can: be a graph-based model, include a set of predefined relationships between each of a set of variables (e.g., include a set of variable rules or formulas), and/or be otherwise structured.

The primary models are preferably financial models, but can additionally and/or alternatively be physical models, mechanical design models, and/or any other suitable models. In examples, the primary model (e.g., drivers, functions, etc.) can be a model (e.g., financial model) disclosed in U.S. application Ser. No. 17/060,587 filed 1 Oct. 2020 and/or U.S. application Ser. No. 18/132,012 filed 7 Apr. 2023 each of which is incorporated in its entirety by this reference.

The primary models are preferably manually defined, but can alternatively be learned or otherwise determined. For example, a set of variables and the associated relationships can be learned or fit to a set of labeled data (e.g., labeled with the variable names, such as a column or row name within a spreadsheet). However, the primary models can be otherwise determined.

The primary model preferably includes a set of variables (e.g., drivers; controllable variables of the model, adjustable variables of the model, independent variables of the model, etc.).

Variables (drivers) are preferably arranged in a hierarchy (e.g., a nested hierarchy), but can additionally and/or alternatively be arranged in a series, and/or otherwise organized. The driver can be a top-level and/or a root-level driver (e.g., a driver with dependencies representing fundamental aspects of a business model); a non-leaf-level driver (e.g., a driver with dependencies); a leaf-level driver (e.g., a driver with no dependencies, a lever, etc.); and/or any other suitable characteristic. Examples of top-level and/or a root-level drivers include: runway; revenue; costs; key performance indicators (KPIs) such as customer acquisition cost (CAC); and/or any other suitable driver. Examples of non-leaf-level drivers include: cash reserves, projected revenue, operating expenses, burn rate, sales revenue, customer segmentation revenue, cost of goods sold (COGS), variable costs, fixed costs, and/or any other suitable drivers. Examples of leaf-level drivers include: employee salary, utilities expense, rent/mortgage payments, travel expenses, licensing fees, product sales revenue, advertising revenue, subscription revenue, and/or any other suitable drivers.

In an illustrative example, examples of drivers for a primary model (e.g., financial model) can include: runway; revenue; costs; gross profit margin; net profit margin; return on investment (ROI); cash; burn rate; other metrics associated with a balance sheet, an income statement, and/or a cashflow statement; and/or any other suitable driver; examples shown in FIG. 3.

Variables (drivers) can be associated with a group or not be associated with a group. For example, when the drivers are not associated with a group, the drivers can be automatically grouped and/or labeled based on existing groups using a machine learning model (e.g., GPT). The groups can be: conceptual groups (e.g., associated with the same output variable, associated with the same topic, etc.); relational groups (e.g., associated with the same output variable, etc.); metadata groups (e.g., associated with the same metadata value); and/or be otherwise defined. A given variable can be part of one or more groups. For example, a “burn” group can include: headcount, salary, rent, benefits, and capital expenses, while a “revenue” group can include: sales, marketing spend, headcount, and efficiency. The groups can be defined by the machine learning model (e.g., an LLM), by a graph search model (e.g., that searches through the primary model for relationships and/or dependencies), by a user, and/or otherwise defined.

Each variable can be: an independent variable (e.g., input variable, wherein the variable is used in a relationship to calculate the value for another variable), dependent variable (e.g., output variable), both an independent variable and a dependent variable, and/or be any other suitable variable.

Each variable can be associated with: a static value, a dynamic value defined by one or more relationships with other variables, a value retrieved from a third party source (e.g., an oracle, a third party database, an API endpoint, etc.), or another value. In variants where the variable is a dynamic value, the relationship can include: equations, functions (e.g., formulas), submodels, rules, and/or any other suitable relationship. The submodels can include: a set of rules, a set of equations (e.g., between the driver and other drivers), a probabilistic model (e.g., ML model, etc.), and/or be otherwise configured.

Each variable can be associated with: a single relationship; different relationships for different condition sets (e.g., different combinations of secondary variable values); different relationships for different timeframes (e.g., past, future, etc.); and/or any other suitable set of relationships. The relationship is preferably a semantic formula (e.g., formula has semantic meaning), but can additionally and/or alternatively be a mathematical formula, a logical formula, a statistical formula, a programming formula, and/or any other suitable formula. The relationship can be used: to calculate one or more values for a driver, used to calculate one or more values for an output of the primary model given the driver, and/or be otherwise used. The relationship is preferably a function of time (e.g., wherein each driver is calculated based on a timestep value for each of a set of timesteps), but can additionally and/or alternatively be a function of other drivers (e.g., wherein the driver value for a given timestep can be calculated based on other driver values for the timestep), and/or a function of other parameters, be time-independent, and/or be otherwise configured. In a first example, a function for leads is marketing spend divided by cost per lead. In a second example, a function for gross profit is cost of goods sold (COGS) subtracted from total revenue. In a third example, a function for customer acquisition cost (CAC) is dividing the total marketing sales expenses by the number of new customers acquired with a specific time period. However, the function for a driver can be otherwise defined.

The function for a variable (e.g., formula that uses the variable as an independent variable, formula to calculate a value of a variable) is preferably semi-automatically determined, but can additionally and/or alternatively be manually determined (e.g., inputted by a user on an interface), automatically determined, and/or otherwise determined. In variants, the function for a driver can be semi-automatically determined using a machine learning model. For example, a foundation model (e.g., GPT) is primed using existing functions (e.g., based on syntax) for other drivers, ingests context (e.g., business related context) and/or a partial function (e.g., a few letters and/or words) for the driver, and outputs a full function for the driver; example shown in FIG. 8. However, the function for a driver can be otherwise determined.

Each variable can be associated with a timeseries of values (e.g., driver values, variable values, etc.), be associated with a static value, and/or be associated with any other suitable value. The value of a driver can be referenced or not be referenced. The driver value can be referenced in a primary model, in a document (e.g., a report, a statement, a slide deck, etc.), and/or be otherwise referenced. The value of a driver is preferably referenced based on a specific time (e.g., a date, a timestep, a timestamp, etc.), but can additionally and/or alternatively be otherwise referenced. In an illustrative example, the value (e.g., $X million) of a driver (e.g., driver_name) is referenced for a date (e.g., MM-DD-YYYY) when a user inputs “@ driver_name” and “MM-DD-YYYY” into the primary model on an interface. However, the value of a driver can be otherwise referenced.

However, the variable value can be otherwise determined.

Each variable can also be associated with a set of metadata, such as a variable description (driver description), variable type (e.g., integer, float, text, audio, image, video, time, etc.), variable unit (e.g., hours, days, months, years, dollars, etc.), constraints (e.g., minimum or maximum range of values, minimum or maximum rate of change, etc.), and/or other metadata. The metadata can be used to determine: the variable description, how the variable can be adjusted, the candidate values for the variable, and/or otherwise used.

However, the one or more primary models can be otherwise configured.

### 4.2. Machine Learning Models

The system 10 and/or method can include and/or be used with one or more machine learning models. The machine learning models can function to: determine candidate plans, select a plan, determine tasks, perform tasks, generate prompts, generate questions to ask the user (e.g., related to context), generate functions, generate explanations, and/or perform other functionalities. The system can include: a single ML model, different ML models for different primary models, different ML models for different prompts, goals, or queries, different ML models for different entity types or industries, different ML models for different primary model types (e.g., different primary model structures), different ML models for different timeframes (e.g., summer vs winter, holiday vs non-holiday, inflation vs deflation, tax increases vs. decreases, interest rate increase vs decrease, growth vs recession, etc.), and/or any number of ML models.

The machine learning models can output: plans, functions, prompts, questions to ask the user, tasks, explanations, and/or any other suitable output.

The machine learning models can receive, as input: drivers (variables), context, prompts (e.g., including goals, constraints, context, etc.), plans (e.g., past plans, current plans, etc.), tasks, primary models, explanations, and/or any other suitable input.

Context can include: a model representation (e.g., representation of the model structure); model values (e.g., current variable values, historic variable values, etc.); entity parameters, such as sector (e.g., healthcare, manufacturing, energy, real estate, transportation, financial, hospitality, etc.) or industry (e.g., equipment, distribution, facilities, etc.); and/or other context. Context is preferably explicitly provided to the ML model; alternatively, the ML model can implicitly add context. For example, even though a mass firing may not be explicitly related to sales or recruiting in the primary model and/or model representation, the ML model can implicitly add a relationship between negative headcount changes and sales or recruiting, due to negative reputational impact (e.g., wherein reputation can be unrepresented in the primary model).

The model representation can include: a description of the model structure or variable relationships (e.g., natural language description), a description of the model groups (e.g., accounting, HR, sales, marketing, etc.), a description of external data sources (e.g., external databases, etc.), a description of each controllable variable (e.g., natural language description of each driver and/or its relationships), a graph representation (e.g., wherein each node represents a variable and the edges represent inter-variable relationships), a tokenized representation (e.g., of the graph or the descriptions), an embedding of the model (e.g., of the model relationships), and/or other representation of the model structure. In variants, the model representation can be used in the context provided to the ML model. The model representation can be generated using a secondary ML model, generated using a template (e.g., wherein the driver names and/or relationships can be populated into the template before providing the model representation to the ML model using variable mapping, based on matching relationships, based on a user query, etc.), manually specified, generated by traversing a variable's relationships, and/or otherwise generated. In a first variant, the model representation is generated by traversing through the variable's relationships in the model, wherein the model representation can include a set of variable equations. In a second variant, the model representation is generated by a secondary ML model, wherein the model representation can include a natural language description of the variable's relationships. In a third variant, the model representation is generated by determining the variable hierarchy or graph. However, the model representation can be otherwise generated.

However, any other context can be used.

The ML model inputs can optionally include one or more prompts. Types of prompts can include: text prompts (e.g., phrases, sentences, paragraphs, etc.), example-based prompts (e.g., include examples of input-output pairs), conditional prompts (e.g., include additional conditions), structured prompts (e.g., include input in a structured format), question-answer prompts (e.g., include a question as input to the model and expecting it to generate an answer based on its understanding of the context), and/or any other suitable prompt types. The prompts are preferably represented as natural language text, but can additionally and/or alternatively be represented as embeddings (e.g., vector representations of text), structured data formats (e.g., JSON, XML, etc.), tokenized sequences, and/or any other suitable representation.

The ML model inputs can optionally include historical data, such as historical plans (e.g., variable values, equations, etc.) and historical results (e.g., historical primary model outputs).

However, the ML model can include any other suitable set of inputs.

The machine learning models can be and/or include: foundation models (e.g., transformer models, large language models (LLMs), etc.), other neural networks (e.g., CNN, DNN, CAN, LSTM, RNN, autoencoders, deep learning models, classifiers, transformers, CV models, etc.), rules, heuristics, an equation (e.g., weighted equations), regression (e.g., leverage regression, curves), classifiers (e.g., binary classifiers, multiclass classifiers, o-shot classifiers, etc.), clustering algorithms (e.g., clustering based on a distance metric, such as cosine similarity), instance-based methods (e.g., nearest neighbor), regularization methods (e.g., ridge regression), decision trees, Bayesian methods (e.g., Naïve Bayes, Markov, etc.), kernel methods, statistical methods (e.g., probability), monte carlo tree search, policies, first order methods, linear programming methods (e.g., branch and bound, etc.), deterministics, support vectors, genetic programs, isolation forests, robust random cut forest, clustering, selection and/or retrieval (e.g., from a database 120 and/or library), comparison models (e.g., vector comparison, image comparison, etc.), object detectors (e.g., CNN based algorithms, such as Region-CNN, fast RCNN, faster R-CNN, YOLO, SSD-Single Shot MultiBox Detector, R-FCN, etc.), feed forward networks, transformer networks, generative algorithms (e.g., diffusion models, GANs, etc.), large language models (LLMs), diffusion models, and/or other neural network algorithms, and/or any other suitable model or methodology. Examples of language models that can be used include: large language models (e.g., LaMDA, GPT-3, GPT-4, BERT, DALL-E 2, SAM, etc.), recurrent neural network language models, feedforward neural network language models, transformer-based language models, probabilistic language models, generative language models, discriminative language models, task-specific language models, statistical language models, visual language models, multimodal language models, domain-specific language models, adversarial language models, cache language models, factored language models, generative pre-trained transformers (e.g., GPT), probabilistic context-free grammars (PCFG), and/or any other suitable language model. The machine learning models can include (e.g., be constructed using) a set of input layers, output layers, and hidden layers (e.g., connected in series, such as in a feed forward network; connected with a feedback loop between the output and the input, such as in a recurrent neural network; etc. ; wherein the layer weights can be learned through training); a set of fully or partially connected convolution layers (e.g., in a CNN); a set of self-attention layers; and/or have any other suitable architecture.

The machine learning models can be trained, learned, fit, predetermined, and/or can be otherwise determined. The machine learning models can be trained (e.g., pre-trained) using self-supervised learning, semi-supervised learning, supervised learning, unsupervised learning, prompt-based learning, transfer learning, reinforcement learning, Bayesian optimization, positive-unlabeled learning, using backpropagation methods (e.g., by propagating a loss calculated based on a comparison between the predicted and actual training target back to the model; by updating the architecture and/or weights of the model based on the loss; etc.), and/or any other suitable training method. The machine learning models can be trained in-house, by a third-party, and/or by any other suitable entity. The machine learning models can be learned and/or trained on: labeled data (e.g., data labeled with the target label), unlabeled data, positive training sets (e.g., a set of data with true positive labels), negative training sets (e.g., a set of data with true negative labels), and/or any other suitable set of data. The machine learning models are preferably trained on a large corpus of data from a wide variety of domains, but can additionally and/or alternatively be trained on data from a limited set of domains (e.g., only language) and/or any other suitable data. The machine learning models can additionally and/or alternatively be tuned (e.g., finetuned), primed, trained, and/or otherwise adjusted using examples of past plans (e.g., given a set of drivers, a primary model, and a past prompt), past tasks (e.g., given a set of past plans), and/or any other suitable data.

However, the one or more machine learning models can be otherwise configured.

### 4.3. Goals

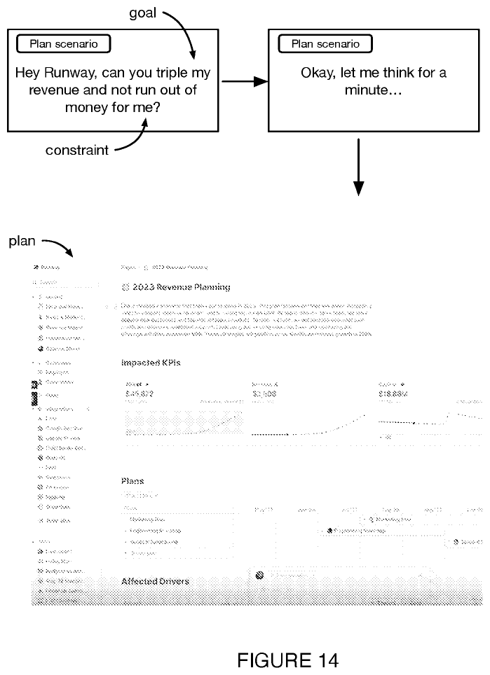

The system 10 and/or method can include and/or be used with one or more goals. Each goal is preferably associated with one or more output variables (outcome, dependent variables, etc.) of the primary model, but can additionally and/or alternatively be associated with one or more primary models, one or more drivers, one or more functions, one or more plans, and/or any other suitable variable. Each goal is preferably associated with one primary model, but can additionally and/or alternatively be associated with multiple primary models, and/or any other suitable number of primary models. The goal can be received from a user (e.g., example shown in FIG. 14), be a predetermined goal, and/or be otherwise determined. The goal is preferably a quantitative goal (e.g., “increase efficiency by 10%”, “achieve a revenue target of $1M”, etc.), but can additionally and/or alternatively be a qualitative goal (e.g., “increase efficiency”, “increase revenue”, etc.), a subjective goal (e.g., “make efficiency better,” “best way to deal with working from home,” “best way to deal with a quarter of the engineering team going on leave,” etc.), and/or any other suitable goal. The goal can include a target value for an outcome (e.g., “$100M ARR”), a relative value for an outcome (e.g., “10×ARR”), a value or relative value for a driver (e.g., “sales headcount of 5 people”, “sales headcount decreasing by 10%”, etc.), and/or any other suitable values; additionally and/or alternatively, the goal can exclude values. The goals can reference output variables explicitly, or not reference output variables (e.g., wherein the ML model infers which output variables are associated with the goal). Example goals can include and/or be associated with: increase in revenue and/or sales; decrease in costs/expenses; increase in profit; increase in gross margin; maintain and/or decrease in burn rate; maintain, increase and/or decrease in other metrics associated with a balance sheet, an income statement, and/or a cashflow statement; expansion of market share; increase customer retention rate; increase website traffic; enhancement of customer satisfaction; increase operational efficiency (e.g., implement process improvements, automation, or lean methodologies); increase brand visibility and/or awareness; enhance employment engagement and retention; geographic expansion; achieve sustainable practices; and/or any other suitable goal. However, the one or more goals can be otherwise configured.

### 4.4. Constraints

The system 10 and/or method can include and/or be used with one or more constraints (e.g., how drivers can be adjusted). Each constraint is preferably associated with one primary model, but can additionally and/or alternatively be associated with multiple primary models, and/or any other suitable number of primary models. Each constraint is preferably associated with one or more drivers (e.g., of a primary model, of multiple primary models, etc.), but can additionally and/or alternatively be associated with one or more primary models, one or more goals, one or more plans, and/or any other suitable variable. Constraints can be received from a user (e.g., example shown in FIG. 14), be predetermined, or be otherwise determined. The constraints are preferably a quantitative constraint (e.g., “$5M budget”, “deadline in 6 months”, “can only increase in value”, etc.), but can additionally and/or alternatively be a qualitative constraint (“government regulations and industry standards compliance”), and/or any other suitable constraint. The constraint can include: an upper limit (e.g., inclusive, exclusive, etc.), a lower limit (e.g., inclusive, exclusive, etc.), trend rate, trend valence, and/or any other suitable limitation. The constraints can be on: variable values, variable value rate of change, or any other derivative thereof. Constraints can include and/or be associated with: financial constraints (e.g., cashflow, budget, etc.); production capacity constraints (e.g., limited factory capacity, bottlenecks, etc.); market competition; regulatory and legal constraints (e.g., licensing requirements); technological limitations and/or disruptions (e.g., outdated or insufficient technology infrastructure, rapid advancement of AI/ML, etc.); resource limitations (e.g., scarcity of raw materials, limited availability of skilled workforce, etc.); economic conditions (e.g., recession, inflation, etc.); geographic constraints (e.g., transportation, logistics, accessibility, etc.); time constraints (e.g., limited timeframes or deadlines); organizational constraints (e.g., bureaucratic constraints); and/or any other suitable constraint. However, the one or more constraints can be otherwise configured.

### 4.5. Plans

The system 10 and/or method can include and/or be used with one or more plans (e.g., for achieving the goals). The plans are preferably generated by the ML model(s), but can additionally or alternatively be generated manually, using an optimization method, or otherwise determined.

Each plan preferably includes target values for one or more of a set of variables, more preferably target values for each of a set of drivers (e.g., input variables; a static target value for each driver, a timeseries of target values for each driver, etc.), but additionally and/or alternatively exclude target values for one or more of the set of drivers, and/or be otherwise defined. The plan is preferably associated with a plurality of timesteps and include different target driver values for each of timestep, but can alternatively be associated with a single timestep.

Each plan is preferably associated with a single primary model, but can alternatively be associated with multiple primary models, and/or any other suitable set of primary models. Each plan is preferably associated a single entity, but can additionally and/or alternatively be associated with multiple entities, and/or any other suitable set of entities.

Plans can include and/or be associated with: marketing (e.g., an aggressive marketing campaign, a conservative marketing campaign, etc.); human resources management (e.g., recruiting, hiring, workforce reduction, onboarding, offboarding, etc.); stakeholders (e.g., investors, partners, employees, contractors, customers, suppliers, regulatory authorities, etc.); fundraising (e.g., series fundraising, crowdfunding, loans, etc.); inventory management (e.g., tracking inventory levels); supplier management (e.g., identify and evaluate suppliers, contract negotiation, etc.); production of goods and delivery of services (e.g., resource requirements, production schedules, quality control, waste minimization, etc.); facilities and equipment (e.g., requirements, lease and/or purchase agreements, etc.); technology infrastructure (e.g., hardware infrastructure, software infrastructure, network infrastructure, data management, cybersecurity, communication, etc.); customer service (e.g., handling inquiries and complaints, maintaining customer relationships, etc.); financial management (e.g., bookkeeping, invoicing, expense management, etc.); regulatory compliance (e.g., taxes, licenses, permits, safety, data protection, etc.); risk management (e.g., operational risks, safety measures, insurance coverage, etc.); sales (e.g., optimize sales processes); and/or any other suitable plan.

However, the one or more plans can be otherwise configured.

### 4.6. Explanations

The system 10 and/or method can include and/or be used with one or more explanations. Explanations can be used in the model representation, in the primary model context, be presented to a user, or be otherwise used.

Each explanation is preferably associated with a single primary model, but can additionally and/or alternatively be associated with multiple primary models, and/or any other suitable number of primary models. The explanation is preferably text-based, but can additionally and/or alternatively be image-based, audio-based, and/or be otherwise represented. Explanations can be determined for: one or more primary models, one or more drivers (e.g., top-level drivers, root-level drivers, non-leaf-level drivers, leaf-level drivers, etc.) and/or driver values, one or more functions, one or more plans (e.g., a set of plans determined in S100, plan selected in S200, other plans, etc.), a combination thereof, and/or any other suitable parameters associated with primary models.

Explanations can provide: a detailed representation (e.g., description) of a value; insight into how a value is determined, how a value can change, what the implications are for a value; relationships for a variable (e.g., how the variable is used as a driver or independent variable within an equation; what other variables the variable value is derived from); and/or any other suitable explanations. Examples of explanations can include: description of a driver (example shown in FIG. 15); explanation of a driver value; description of a function; description of a plan; description of a page on an interface 130; explanation of relationships between drivers, driver values, and/or plans; explanation of a change (e.g., between versions when engaging with the primary model); explanation of a prediction (e.g., into the future); explanation of a reflection (e.g., on the past); and/or any other suitable explanations. In a first illustrative example, a description of a driver includes what the driver does and/or how the function associated with the driver works. In a second illustrative example, an explanation of a driver value includes an explanation of why there is variance (e.g., variance percentage) for a driver. In a third illustrative example, a description of a plan includes an explanation of what a plan does. In a fourth illustrative example, an explanation of a prediction (e.g., into the future) includes an explanation of how a predicted driver value is determined. In a fifth illustrative example, an explanation of a reflection (e.g., on the past) includes an explanation of what is the difference (e.g., how far off) between a prior prediction of a driver value for a driver (e.g., a budget forecast from last year) and a current driver value for the driver (e.g., a realization of that budget this year). However, the explanation can include any other suitable information.

However, the one or more explanations can be otherwise configured.

The system 10 can include one or more computing systems 110, which can function to execute all or portions of the method, execute one or more modules of the system 10, and/or perform any other suitable functionality. The computing system 110 is preferably a remote computing system (e.g., a platform, a server system, etc.), but can additionally and/or alternatively be performed by a distributed computing system, a local computing system (e.g., a user device such as a smartphone, a laptop, a desktop, a tablet, etc.), a centralized computing system, a combination thereof, and/or any be otherwise configured. The computing system 110 can optionally interface with the one or more databases 120. The computing system 110 can be used with an interface 130 or not be used with an interface.

In variants, the one or more computing systems 10 can include one or more computing modules, which can function to facilitate execution of method elements. The one or more computing modules can be executed contemporaneously, synchronously, asynchronously, in series, in parallel, and/or be otherwise implemented. In a first example, the computing system 110 can include a first computing module which functions to determine a set of plans in accordance with S100, a second computing module which functions to select a plan in accordance with S200, a third computing module which functions to determine a set of tasks for the selected plan in accordance with S300, a. fourth computing module which functions to perform the set of tasks in accordance with S400, and a fifth computing module which functions to determine a set of explanations in accordance with S500. In a second example, the computing system 110 can include a single computing module which can function to facilitate execution of an instance of the method. However, the one or more computing modules can be otherwise configured.

However, the one or more computing systems 110 can be otherwise configured.

The system 10 can optionally include or interface with one or more databases 120, which can function to store data such as: primary models, ML models, drivers, driver values, functions, plans, prompts, prompt templates, explanations, relationships between any of the aforementioned data, and/or any other suitable information. The database 120 can be a remote database, a local database, a distributed database, a centralized database, a cloud database, a combination thereof, and/or any be otherwise configured. The database 120 can be a NoSQL database, a relational database (RDS), a hierarchical database, and/or any other suitable database. The database 120 can be queryable or not be queryable. The database 120 can be and/or interface with a third-party source (e.g., a third-party database) or not interface with a third-party source. The information in the database 120 can be retrieved from, linked to, and/or be otherwise associated with a third-party source. The information stored in the databases 120 can be determined automatically (e.g., via APIs, through an interface 130 such as a graphical user interface, etc.), manually (e.g., by a user), and/or otherwise determined.

However, the one or more databases 120 can be otherwise configured.

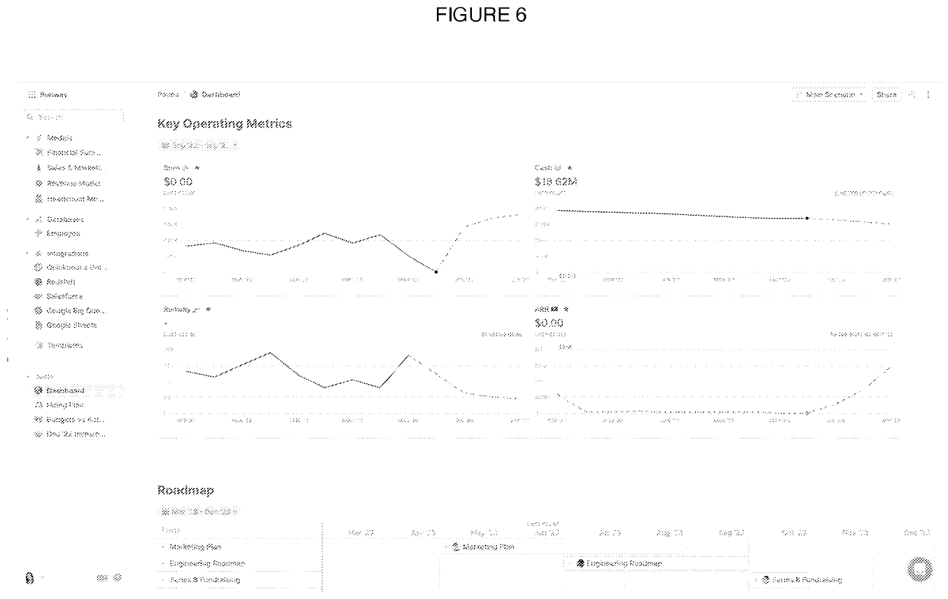

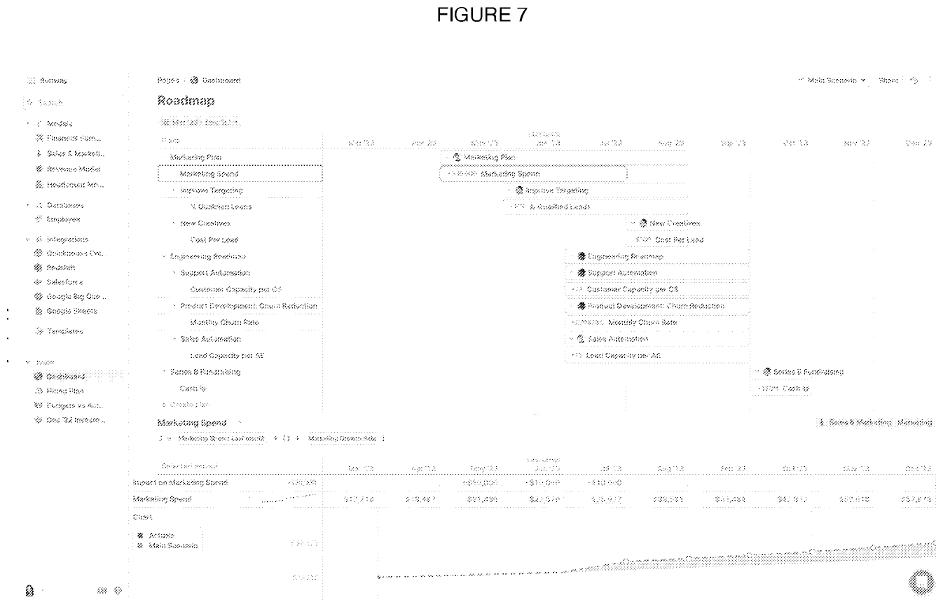

The system 10 can optionally include one or more interfaces 130, which can function to receive from and/or present information to a user. The interface 130 can be used to: create a primary model (e.g., financial model); present a primary model and drivers associated with the primary model; receive and/or input drivers and/or driver values; receive and/or input plan generation requests; present candidate plans and/or selected plan; and/or be otherwise used. The interface 130 is preferably a graphical user interface (examples shown in FIG. 3, FIG. 4, FIG. 5, FIG. 6, and FIG. 7), but can additionally and/or alternatively be a command line interface, an application programming interface (API), a voice user interface, a touch user interface, and/or any other suitable type of interface. The interface 130 is preferably an application (e.g., browser application, native application, etc.) on a user device (e.g., laptop, desktop, mobile phone, tablet, etc.), but can additionally and/or alternatively be an API, and/or any other suitable interface. The user input and/or user selection is preferably tactile based (e.g., typing in text, pressing a digital button, dragging & dropping, etc.), but can additionally and/or alternatively be voice-based, motion-based, and/or any other suitable user input and/or selection.

However, the one or more interfaces 130 can be otherwise configured.

However, the system 10 can include any other suitable components.

### 5. Method

The method for plan generation can include: determining a set of plans S100, selecting a plan S200, optionally determining a set of tasks for the selected plan S300, optionally performing the set of tasks S400, and optionally determining a set of explanations S500. Additionally and/or alternatively, the method can include any other suitable elements.

The method can function to determine a set of plans for an entity (e.g., company, individual, etc.) based on a set of goals (e.g., desired outcomes of drivers), a set of constraints (e.g., constraints of drivers, constraints of other variables, etc.), and a primary model. However, the method can have any other suitable functionality.

All or portions of the method can be repeated for different entities, different timeframes, different plans, different drivers, different goals, different constraints, different explanations, and/or otherwise repeated.

All or portions of the method can be performed in real-time (e.g., responsive to a request), iteratively, concurrently, sequentially, asynchronously, randomly, periodically, repeatedly, continuously, recurrently (e.g., daily, hourly, etc.), upon receipt of a request (e.g., plan generation request), upon occurrence of a predetermined event, prior to a request, once, and/or at any other suitable time and/or frequency.

The method is preferably performed automatically (e.g., using one or more primary models, using one or more machine learning models, etc.), but can additionally and/or alternatively be performed manually (e.g., by one or more stakeholders of an entity), semi-automatically (e.g., using one or more machine learning models and by one or more stakeholders of an entity), a combination thereof, and/or otherwise performed. The method is preferably performed without any user-entered lines of code, but can additionally and/or alternatively be performed with user-entered lines of code, and/or otherwise be performed. The method is preferably performed by the system 10 disclosed above, but can additionally and/or alternatively be performed by a computing system (e.g., a remote computing system, a local computing system, a distributed computing system, etc.), a user, and/or by any other suitable system.

However, the method can be otherwise performed.

### 5.1. Determining a Set of Plans S100

Determining a set of plans S100 functions to generate one or more plans for an entity that achieves a set of goals, given a set of constraints, based on a set of drivers of a primary model. S100 is preferably performed before S200, but can additionally and/or alternatively be performed concurrently with S200, after S200, before S500, concurrently with S500, after S500, and/or at any other suitable time.

The set of plans (described above) can include one plan, multiple plans, and/or any plans suitable number of plans; examples shown in FIG. 6 and FIG. 7. In an example, the set of plans includes: a marketing campaign (e.g., an aggressive marketing campaign), a fundraising (e.g., a $100M fundraising), and hiring in the sales department (e.g., double the number of employees on the sales team). In another example, the set of plans only includes increasing customer retention. However, the set of plans can include any other suitable plan.

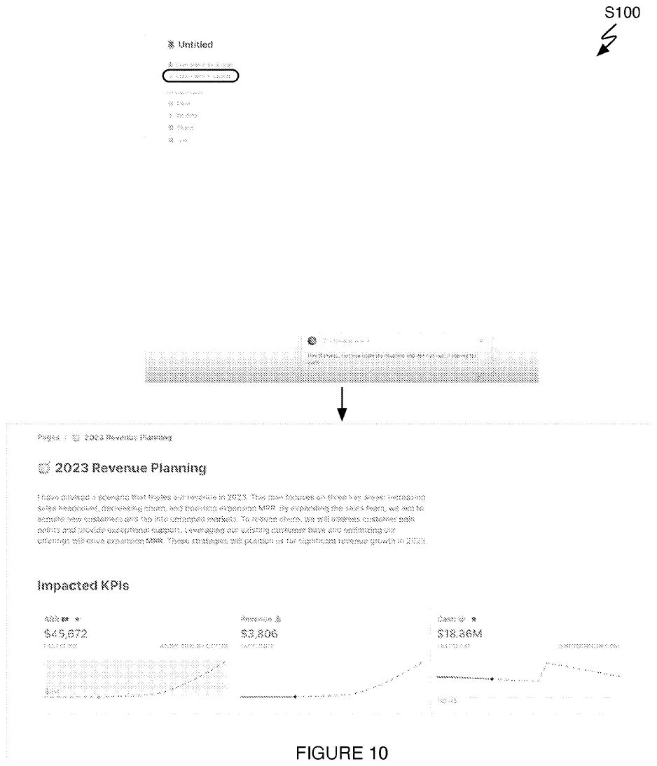

The set of plans can be determined based on prompt(s) or not be determined based on prompt(s). The prompt can include goals (described above), constraints (described above), context (e.g., existing plan context, business related context, model representations, etc.), plan types (e.g., marketing related, fundraising related, hiring related, etc.), and/or any other suitable information. Examples of context can include: existing plan context (e.g., roadmaps, strategy, project plans, financial plans, etc.), business related context (e.g., entity characteristics such as industry and/or sector, consumer vs. enterprise, software vs. hardware, market research data, customer profiles, technological trends, economic conditions, organizational culture, employee data, fundraising data, etc.), the model structure representation, model values (e.g., current variable values), historical model values (e.g., historical variable values), and/or any other suitable context. In an illustrative example, the prompt includes: increasing the revenue of the company within a year by a multiple without running out of cash for a software enterprise startup; example shown in FIG. 10. All or portions of the prompt can be determined: by the entity (e.g., one or more stakeholders of an entity), by a third-party (e.g., Jira™, Notion™, Asana™, etc.), automatically (e.g., using one or more machine learning models), semi-automatically (e.g., using one or more machine learning models and by one or more stakeholders of an entity), manually, be a set of predetermined prompts, and/or otherwise determined. In a first variant, a prompt that includes the set of goals and/or constraints can be generated by a machine learning model (to prompt itself). In a second variant, the prompt that includes context (e.g., existing plan context) is determined based on a third-party source. For example, existing plans (e.g., roadmap of fundraising, roadmap that involves product launch, roadmap of future products built by engineering team, etc.) from third-party sources (e.g., Jira™, Notion™, etc.) are used as context within the prompt. In an illustrative example, values from the third-party sources are mapped to variables within the primary model, wherein the model representation (included in the context) is determined based on the third-party values. In a third variant, the prompt that includes context (e.g., business related context) is determined by the entity. For example, business related information (e.g., description of what the entity does) provided by the sales team is used as context within the prompt. However, the prompt can be otherwise determined.

The prompt is preferably inputted into a machine learning model (e.g., GPT), but can additionally and/or alternatively be inputted into a different model, stored in a database 120, and/or otherwise used.

The set of plans can be determined based on driver(s) (described above) or not be determined based on driver(s). Examples of drivers (e.g., drivers related to revenue) include: average monthly pricing, new MRR, churched MRR, payment delay, and/or any other suitable metric; example shown in FIG. 5. The drivers are preferably inputted into a machine learning model (e.g., GPT), but can additionally and/or alternatively be stored in a database 120, and/or otherwise used. The drivers are preferably provided as part of the prompt (e.g., part of the context within the prompt), but can alternatively be provided separately (e.g., as part of a different input or input head). In an example, S100 can include: determining a set of drivers (e.g., input variables, controllable variables, independent variables, etc.) associated with a goal (e.g., independent variables associated with a given dependent variable); determining a description of each drivers' relationship with the goal (e.g., relationship between each independent variable and the dependent variable); and including the descriptions in the prompt (e.g., as context), alongside the goal. However, driver information can be otherwise determined and provided to the ML model.

Plans of the set are preferably determined contemporaneously and/or simultaneously, but can additionally and/or alternatively be determined asynchronously, and/or be otherwise determined. The set of plans is preferably determined automatically (e.g., using one or more machine learning models, using optimization, using MCTS, using a policy, using enumeration, using trial-and-error, etc.), but can additionally and/or alternatively be determined manually (e.g., by one or more stakeholders of an entity), semi-automatically (e.g., using one or more machine learning models and by one or more stakeholders of an entity), and/or otherwise determined.

In a first variant, S100 can include: providing the drivers and a prompt into a machine learning model (e.g., GPT), wherein the machine learning model generates a set of candidate plans; running each candidate plan on the primary model to simulate model outputs; wherein a candidate plan is selected based on the model outputs (e.g., how closely the model output achieves the goal).

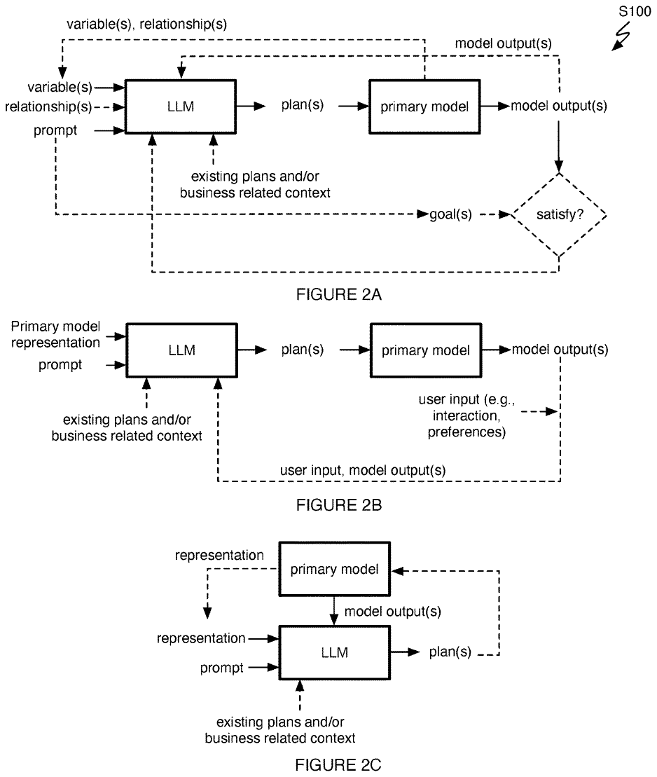

In a second variant, S100 can be similar to the first variant, but optionally include providing the simulated model outputs back to the machine learning model as feedback, wherein the machine learning model can optionally generate updated plans based on the feedback. When the simulated model outputs are provided back to the machine learning model, the machine learning model can optionally be updated based on the simulated model outputs. Updating the machine learning model can include: retraining the machine learning model, finetuning the machine learning model, priming the machine learning model, instructing the machine learning model to treat the simulated model output (and optionally the associated candidate plan) as context, and/or otherwise updating the machine learning model. An example shown in FIG. 2A. In this variant, each candidate plan can optionally be subdivided (e.g., by time, by entity or department, by context, by outcome, etc.) into subplans. For example, groups of plans can be organized based on time (e.g., yearly, quarterly, monthly, etc.). In an illustrative example, when planning across a year, groups of subplans can be organized by quarter (e.g., Q1 marketing spend, Q2 marketing spend, Q3 marketing spend, Q4 marketing spend, etc.).

In a third variant, S100 can be similar to the first variant, but receive user input on the simulated model outputs. The user input can optionally be provided back to the machine learning model (e.g., as feedback, as context, etc.), optionally alongside the simulated model outputs, wherein the machine learning model can generate an updated set of candidate plans given the user input and optionally the simulated model outputs. Examples of user inputs can include: evaluating whether the simulated model output satisfies the prompt (e.g., the goal), feedback on advantages and/or disadvantages of the plan (e.g., “we cannot hire that quickly”, “the cost for material x is too high”), additional constraints, setting driver values, and/or other user inputs. An example is shown in FIG. 2B.

In a fourth variant, S100 can be similar to the first variant, except that the primary model can also be provided to the machine learning model. An example is shown in FIG. 2C.

In a fifth variant, S100 can be similar to the first variant, except that only the driver names are provided to the machine learning model (e.g., a model representation is not provided to the ML model).

However, the set of plans can be otherwise determined.

### 5.2. Selecting a Plan S200

Selecting a plan S200 functions to determine a final plan to be executed (e.g., manually executed, automatically executed, semi-automatically executed, etc.). S200 is preferably performed after S100, but can additionally and/or alternatively be performed concurrently with S100, before S300, before S400, before S500, concurrently with S500, after S500, and/or at any other suitable time. The plan is preferably selected from the set of plans (e.g., determined in S100), but can additionally and/or alternatively be selected from a different set of plans, randomly selected, and/or otherwise selected. The plan is preferably selected automatically (e.g., using one or more machine learning models), but can additionally and/or alternatively be selected manually (e.g., by one or more stakeholders of an entity), semi-automatically, a combination thereof, and/or otherwise selected. The plan can be selected based on how closely the model output matches the goal (e.g., based on a proximity metric, distance metric, value difference, cosine similarity, etc.), randomly selected, and/or otherwise selected.

In a first variant, S200 can include automatically selecting the plan from the set of plans. The plan can be selected using the machine learning model from S100, a secondary machine learning model, using a set of rules or heuristics, and/or be otherwise determined. In a first example of the first variant, plans of the set are ranked based on heuristics and the highest ranked plan is selected. In a second example of the first variant, the plan with model outputs (e.g., of the primary model) most closely matching the goal is selected (e.g., the candidate plan that generates an ARR closest to the target ARR; the candidate plan that achieves a growth rate closest to the target growth rate, etc.).

In a second variant, S200 can include manually selecting the plan from the set of plans by a user (e.g., a stakeholder) on an interface 130 (e.g., GUI).

In a third variant, S200 can include a combination of the above variants: automatically selecting the plan from the set of plans and manually selecting the plan. For example, plans of the set are filtered based on heuristics and a final plan is selected by a user on an interface 130.

In a fourth variant, S200 includes selecting the candidate plan resulting in an output that semantically best matches the goal. The semantic proximity between the output and the goal can be determined based on: embedding proximity (e.g., wherein a ML model is prompted to describe the output, then the description is embedded into a semantic space with the goal, wherein the candidate plan with the closest embedding is selected); quantitative proximity (e.g., wherein an ML model determines a set of dependent variables based on the goal, wherein the candidate plan with the best values for the dependent variables is selected); and/or otherwise determined.

However, the plan can be otherwise selected.

The selected plan can be subsequently implemented (e.g., manually, using S300, etc.), sent to a user for further evaluation, and/or otherwise used.

### 5.3 Determining a Set of Tasks for the Selected Plan S300

The method can optionally include determining a set of tasks for the selected plan S300, which functions to determine actionable tasks (e.g., a plan of action) associated with the selected plan. S300 is preferably performed after S200, but can additionally and/or alternatively be performed concurrently with S200, before S400, before S500, concurrently with S500, after S500, and/or at any other suitable time. The set of tasks can include: one task, multiple tasks, and/or any other suitable number of tasks. Each task can be associated with a set of stakeholders, or not be associated with a set of stakeholders. Each task can be associated with a time constraint (e.g., limited timeframes or deadlines) or not be associated with a time constraint. Examples of tasks can include and/or be associated with: identifying which stakeholders to contact (e.g., incorporating company structure information to understand roles for employees, identifying venture capital firms that fit the company's criteria, etc.); identifying required documents (e.g., pitch decks, contracts/agreements, licenses/permits, financial statements/documents, insurance policies, intellectual property, compliance, etc.); identifying instructions for completing the task, and/or any other suitable task. The set of tasks is preferably determined automatically (e.g., using one or more machine learning models), but can additionally and/or alternatively be determined manually (e.g., by one or more stakeholders of an entity), semi-automatically (e.g., using one or more machine learning models and by one or more stakeholders of an entity), a combination thereof, and/or otherwise determined.

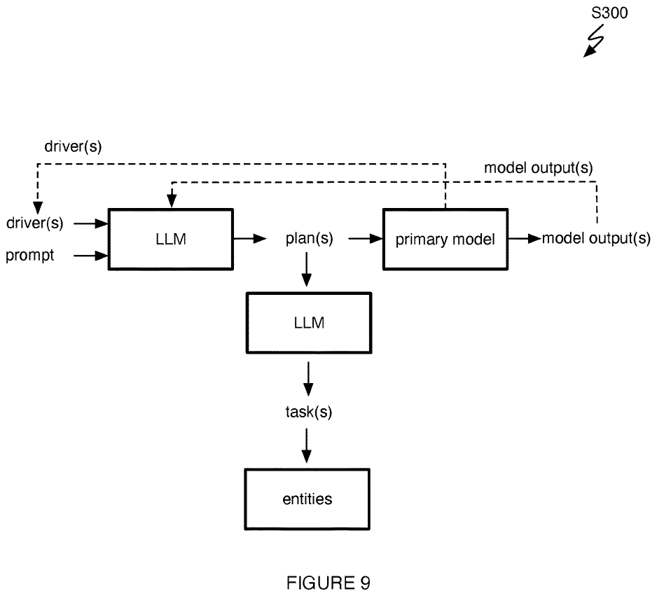

In a first variant, S300 can include automatically determining the set of tasks for the selected plan using a machine learning model (e.g., the same or different machine learning model from S100, the same or different machine learning model from S500, etc.). For example, a LLM receives, as input, the selected plan, context, entity characteristics, and/or an entity stakeholder database and outputs the set of tasks; example shown in FIG. 9.

In a second variant, S300 can include manually determining the set of tasks for the selected plan. For example, multiple tasks are brainstormed and/or evaluated (e.g., prioritized based on urgency and/or importance) by an employee (e.g., a C-level executive, a consultant, etc.) at the entity, wherein the set of tasks for the selected plan is finalized by the employee.

In a third variant, S300 can include a combination of the above variants: automatically determining the set of tasks for the selected plan and manually determining the final set of tasks from the set of tasks. For example, a set of tasks are generated by a machine learning model, and a final set of tasks from the set of tasks is selected by a user on an interface 130.

However, the set of tasks can be otherwise determined.

### 5.4 Performing the Set of Tasks S400

The method can optionally include performing the set of tasks S400, which functions to implement the set of tasks for the selected plan. S400 is preferably performed after 300, but can additionally and/or alternatively be performed concurrently with S300, before S500, concurrently with S500, after S500, and/or any other suitable time. The set of tasks can include one task, multiple tasks, and/or any other suitable number of tasks. Examples of performing the set of tasks can include: processing emails (e.g., writing, sorting, categorizing, forwarding, etc.) with stakeholders; scheduling meetings (e.g., in-person, video conferencing, calls, etc.) with stakeholders; creating documents (e.g., pitch decks, employee contracts, reports, invoices, etc.); extracting, validating, and/or standardizing data from sources (e.g., spreadsheets, documents, databases, etc.); generating and/or posting job listings; managing projects (e.g., using project management tools to track progress, manage tasks, and meet project deadlines); performing administrative tasks (e.g., filling out timesheets, expense reports, and/or other paperwork); performing software engineering tasks (e.g., creating high-level designs and architectures for software systems such as defining components, interfaces, and data structures, writing code for front-end and/or back-end development, testing and/or debugging, using version control systems, writing technical documentation, etc.); and/or other suitable task performance. The set of tasks is preferably performed automatically (e.g., using one or more machine learning models), but can additionally and/or alternatively be performed manually (e.g., by one or more stakeholders of an entity), semi-automatically (e.g., using one or more machine learning models and by one or more stakeholders of an entity), a combination thereof, and/or otherwise performed. However, the set of tasks can be otherwise performed.

### 5.5. Determining a Set of Explanations S500

The method can optionally include determining a set of explanations S500, which functions to determine human readable explanations. The explanations can be used as part of the model context (e.g., in S100), be provided to a user (e.g., on an interface), and/or otherwise used. S500 can be performed before S100, after S200, concurrently with S200, before S200, after S100, and/or any other suitable time. The set of explanations can include one explanation, multiple explanations, and/or any other suitable number of explanations. The set of explanations can be determined for: one or more primary models, one or more drivers (e.g., top-level drivers, root-level drivers, non-leaf-level drivers, leaf-level drivers, etc.) and/or driver values, one or more variables (e.g., dependent variables) one or more functions, one or more plans (e.g., a set of plans determined in S100, plan selected in S200, other plans, etc.), a combination thereof, and/or any other suitable parameters associated with primary models.

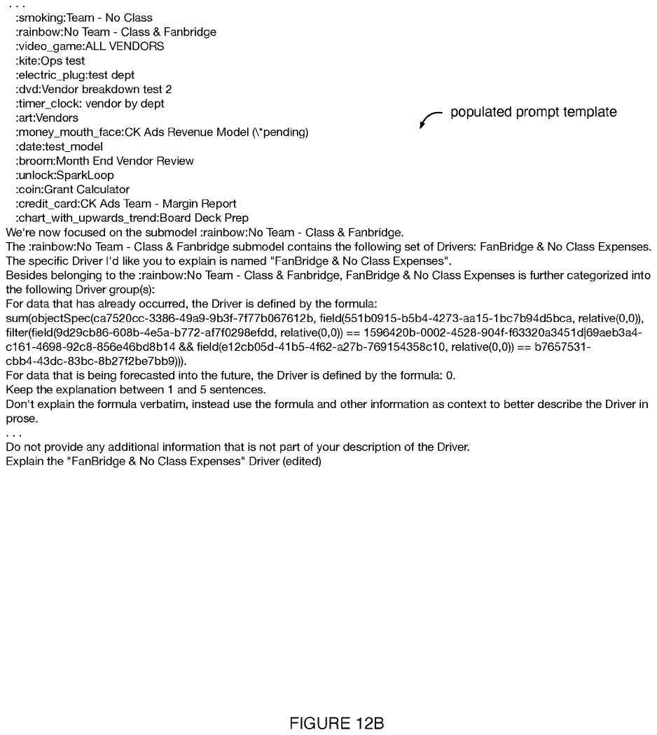

The explanation can be determined based on prompt(s) or not be determined based on prompt(s). The prompt can include: drivers, driver values, any values derived from driver values (e.g., summary of driver values), context (e.g., business related context, existing plan context), explanations, plans, and/or any other suitable information; examples shown in FIG. 12A and FIG. 12B. The prompt can be specific to a vertical (e.g., vertical market), explanation type (e.g., description of a driver, explanation of a driver value, explanation of a prediction, explanation of a reflection, explanation of a change, etc.), and/or be otherwise specific. Additionally and/or alternatively, the prompt can be generic across verticals, explanation types, and/or be otherwise generic. The prompt is preferably inputted into a machine learning model (e.g., GPT), but can additionally and/or alternatively be inputting into a different model, stored in a database 120, and/or otherwise used.

Explanations of the set can be determined contemporaneously, simultaneously, asynchronously, synchronously, and/or otherwise determined. The set of explanations is preferably determined automatically (e.g., using one or more machine learning models), but can additionally and/or alternatively be determined manually (e.g., by a user), semi-automatically (e.g., by a user and using one or more machine learning models), and/or otherwise determined. The set of explanations is preferably determined without user request (e.g., without text-based queries entered by the user, pre-generated prior to a user requesting an explanation, etc.), but can additionally and/or alternatively be determined based on user request (e.g., of a particular explanation), randomly, and/or otherwise determined.

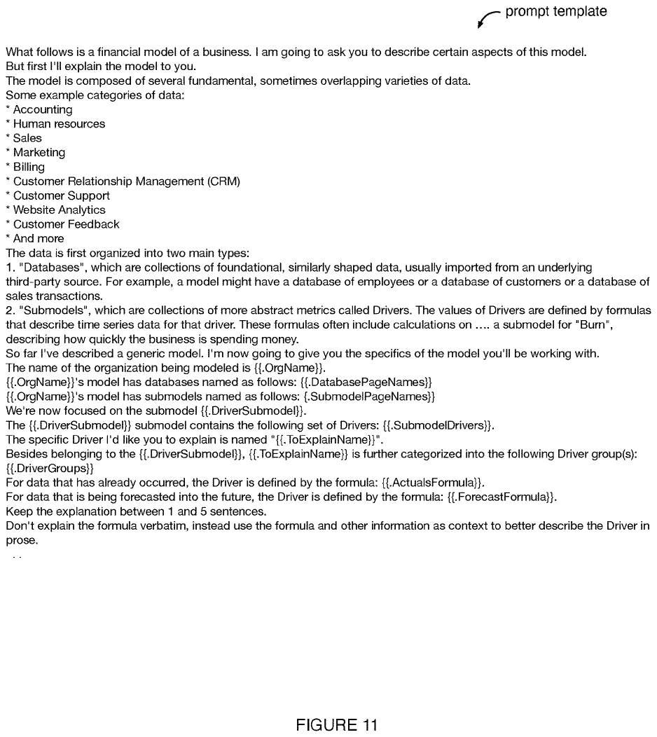

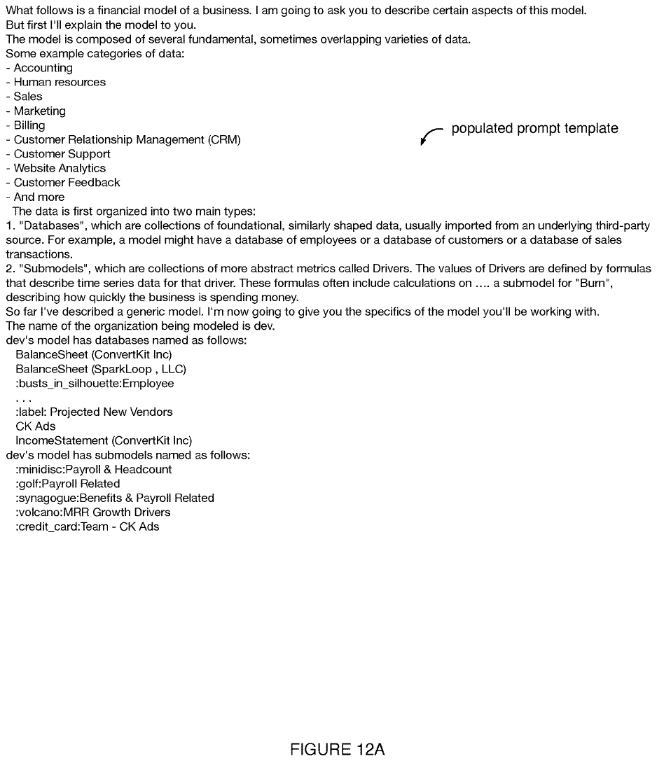

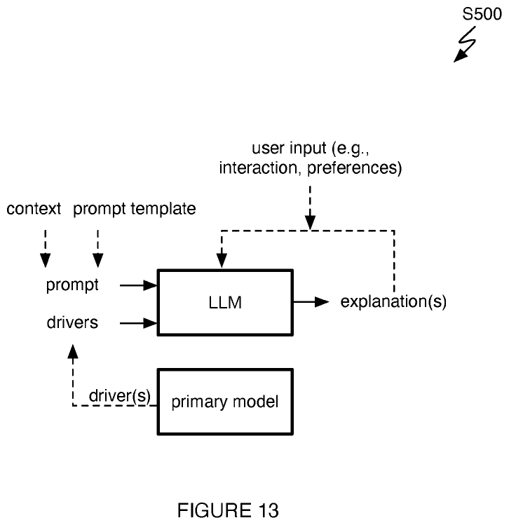

In a first variant, S500 can include: determining a prompt and providing a set of drivers of a primary model and the prompt into a machine learning model (e.g., GPT), where the machine learning model (e.g., the same or different machine learning model from S100) generates a set of explanations; and optionally providing the set of explanations back to the machine learning model as feedback, where the machine learning model can optionally generate updated explanations based on the feedback; example shown in FIG. 13. In this variant, the prompt is preferably determined automatically (e.g., generated based on a prompt template, retrieved from a database 120, etc.), but can additionally and/or alternatively be determined manually (e.g., by a user on an interface 130), semi-automatically, and/or otherwise determined. In an example of this variant, the prompt is automatically generated based on a prompt template (example shown in FIG. 11), where the prompt is determined by populating the prompt template with context (e.g., drivers, driver values, functions, plans, etc.); examples shown in FIG. 12A and FIG. 12B. In this example, the template can be populated with primary model information (e.g., variable metadata) using variable mapping (e.g., variable bindings) or otherwise populated. In an example, filling the template can include: determining a set of variables associated with a goal (e.g., received from the user, determined automatically, etc.); determining the variable metadata or parameters required by the template (e.g., variable name, data sources, equations, etc.), and filling in the template with the determined variable metadata. However, the prompt template can be otherwise populated.

In examples, the prompt template can additionally include inference instructions, such as definitions of object types (e.g., model definitions, database definitions, submodel definitions, driver definitions); natural language instructions on what to include or what to exclude (e.g., do not mention that the driver is a time series, do not mention the driver by name, do not explain the formula verbatim, keep the explanation to less than N sentences, etc.); and/or other information.

In examples, the prompt template can be determined based on an explanation type (e.g., description of a driver, explanation of a driver value, description of a plan, etc.), such that the same prompt template is used for the same explanation type for explanations. The prompt template is preferably automatically determined (e.g., retrieved from a database 120), but can additionally and/or alternatively be received from a third-party, and/or otherwise determined. However, the prompt template can be otherwise determined. In another example of this variant, the prompt is automatically generated through an iterative process. In this example, the (final) prompt can be determined by: determining an initial prompt (e.g., naïve prompt), testing different versions (e.g., add and/or remove structure and/or content, etc.) of the initial prompt through A/B testing, and/or refining the initial prompt based on the results of the A/B tests to determine the final prompt, wherein the final prompt is inputted into a machine learning model. However, the (final) prompt can be otherwise determined. However, the prompt can be otherwise determined.

In a second variant, S500 can be similar to the first variant, but receive user input on the generated set of explanations. The user input can optionally be provided back to the machine learning model (e.g., as feedback, as context, etc.), optionally alongside the generated set of explanations, wherein the machine learning model can generate an updated set of explanations given the user input and optionally the generated set of explanations. Examples of user inputs can include: feedback on advantages and/or disadvantages of the explanation (e.g., “explanation is too short and/or too long”, “explanation needs to be more elaborate”, etc.), variables (e.g., drivers, driver values, etc.) to account for and/or discount in the explanation, and/or other user inputs.

In a third variant, S500 can be similar to the first variant, except that the primary model can also be provided to the machine learning model.

In a fourth variant, S500 can include: providing the variable relationship(s) (e.g., equations) to the machine learning model, and prompting the ML model to generate a description. The description is preferably a qualitative or narrative-based description, but can alternatively be a quantitative description. In this variant, the ML model can use both the equations and the semantic meaning of the variable names to generate the description; alternatively, the ML model can use the equations and data extracted from the variable values (e.g., values themselves, timeseries of values, etc.) to determine the description (e.g., using the object identifier for the variable, using the semantic identifier for the variable, etc.), or otherwise generate the description. In a first example, S500 includes providing the relationship (e.g., equation) between an output variable (dependent variable) and one or more driver variables (independent variables) to the model, and prompting the ML model to generate a description for the output variable. In a second example, S500 includes providing the relationships (e.g., equations) between a set of output variables and a given input variable (driver, independent variable), and prompting the ML model to generate a description for the input variable (driver, independent variable).

However, the set of explanations can be otherwise determined.

S500 can optionally include providing the set of explanations to an endpoint through an interface. The endpoint is preferably an interface 130, but can additionally and/or alternatively be an endpoint on a network, a customer endpoint, a user endpoint, a document, and/or any other suitable endpoint. The interface 130 can be on a web application, a mobile application, a desktop application, an API, and/or any other suitable interface executing on a user device, gateway, and/or any other suitable computing system. For example, when a user uses an interface 130 (e.g., graphical user interface) and moves the cursor around to interface with a primary model, an explanation (e.g., pre-generated explanation) is displayed for a driver and/or driver value associated with the primary model that the cursor is hovering (e.g., in a mouseover); example shown in FIG. 15.

However, the method can be otherwise performed.

In a first illustrative example, the system and/or method can include: determining a primary model including a set of variables interrelated by a set of relationships; determining a representation of the primary model (e.g., natural language description of the variables' relationships with other variables and/or other data sources); determining a set of goals for the primary model; generating a set of plans (e.g., including a value or timeseries of values for a subset of variables from the model, etc.) using a machine learning model (e.g., generative model, foundation model, etc.) based on the set of goals and the representation of the primary model; determining a set of simulated model outputs by running each plan of the set of plans through the primary model; and selecting a plan from the set of plans based on a similarity between the respective simulated model output and the set of goals (e.g., distance metric, proximity, etc.). In variants, the set of plans can additionally or alternatively be generated based on: primary model context (e.g., third party data, the primary model structure representation, variable names, variable equations, descriptions of dependent or independent variables, etc.); a set of constraints (e.g., on variable values); and/or other information. In variants, this information can be contained within a model prompt, wherein the prompt can be automatically generated by filling in variable parameter values. For example, the prompt can include tags or placeholders for variable names, variable equations, and/or other variable information, wherein variable information values from the primary model can be retrieved and filled into the placeholders. The variables that are used to fill into the prompt can be variables associated with the goal (e.g., automatically determined, determined based on the dependent variable associated with the goal, etc.), requested variables, and/or other variables. In variants, the set of simulated model outputs or user feedback on the set of simulated model outputs are provided as feedback back to the machine learning model, wherein the machine learning model determines an updated set of plans for the set of goals based on the feedback. In variants, a description of the selected plan can be determined using the same or different machine learning model.

In a second illustrative example, the system and/or method can: determine a primary model including a set of interrelated variables; for a variable from the set of interrelated variables, generate a natural language prompt based on relationships associated with the variable from the primary model; and generate a natural language descriptor of the variable using a machine learning model (e.g., generative model), given the natural language prompt. In variants, the set of natural language descriptor of the variable is displayed responsive to a mouseover event associated with an interface object for the variable. In variants, the natural language prompt is generated using semantic names for secondary variables associated with the variable, wherein the natural language descriptor of the variable is determined based on the semantic names.

However, the system and/or method can be otherwise configured.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method, comprising:
determining a set of drivers associated with a primary model;
determining a set of goals for the primary model;
generating a set of plans using a machine learning model based on the set of drivers and the set of goals;
determining a set of simulated model outputs by running each plan of the set of plans on the primary model; and
selecting a plan from the set of plans based on a proximity between the respective simulated model output and the set of goals.

2. The method of claim 1, further comprising:
providing the set of simulated model outputs to the machine learning model as feedback; and
determining a set of updated plans using the machine learning model based on the feedback.

3. The method of claim 1, wherein each plan of the set of plans comprises a set of proposed values for the set of drivers.

4. The method of claim 1, wherein the proximity for a plan is based on a distance metric between the set of goals and the respective simulated model output.

5. The method of claim 4, further comprising:
determining a set of tasks for the selected plan using the machine learning model; and
performing the set of tasks using the machine learning model.

6. The method of claim 1, wherein the primary model context comprises a representation of a structure of the primary model.

7. The method of claim 1, wherein each driver of the set of drivers comprises a set of driver values, wherein the set of explanations comprises an explanation for each driver of the set of driver values.

8. The method of claim 1, further comprising determining a prompt based on a set of constraints for the set of drivers, the set of goals, and a primary model context, wherein the set of plans is generated based on the prompt, wherein the machine learning model receives the set of drivers and the set of prompt as input, and outputs the set of plans.

9. The method of claim 8, wherein a prompt of the set of prompts is determined by populating a prompt template with the primary model context, wherein the prompt template is determined based on an explanation type.

10. The method of claim 1, further comprising displaying an explanation from the set of explanations for a driver of the set of drivers within a mouseover of the driver.

11. A system, comprising:
a processing system, configured to:
determine a primary model comprising a set of variables interrelated by a set of relationships;
determine a representation of the primary model;
determine a set of goals for the primary model;
generate a set of plans using a machine learning model based on the set of goals and the representation of the primary model;
determine a set of simulated model outputs by running each plan of the set of plans through the primary model; and
select a plan from the set of plans based on a similarity between the respective simulated model output and the set of goals.

12. The system of claim 11, wherein the processing system is further configured to:
receive user input on the set of simulated model outputs;
provide the user input to the machine learning model as feedback; and
determine a set of updated plans using the machine learning model based on the feedback, the representation of the primary model, and the set of goals.

13. The system of claim 11, wherein the representation for the primary model comprises a description for each independent variable of the set of variables.

14. The system of claim 11, wherein each plan comprises values for a subset of the set of variables that are associated with the goal.

15. The system of claim 11, wherein the set of simulated model outputs are provided as feedback back to the machine learning model, wherein the machine learning model determines an updated set of plans for the set of goals based on the feedback.

16. The system of claim 11, wherein the processing system is further configured to determine a description of the selected plan using the machine learning model.

17. The system of claim 11, wherein the machine learning model comprises a generative model.

18. A model explanation system, comprising a processing system configured to:
determine a primary model comprising a set of interrelated variables;
for a variable from the set of interrelated variables, generate a natural language prompt based on relationships associated with the variable from the primary model; and
generate a natural language descriptor of the variable using a generative model, given the natural language prompt.

19. The model explanation system of claim 18, wherein the natural language descriptor of the variable is displayed responsive to a mouseover event associated with an interface object for the variable.

20. The model explanation system of claim 18, wherein the natural language prompt is generated using semantic names for secondary variables associated with the variable, wherein the natural language descriptor of the variable is determined based on the semantic names.
